(19) United States
(12) Patent Application Publication
(10) Pub. No.: US 2007/0028062 A1
(43) Pub. Date: Feb. 1, 2007

(54) Ripple Queuing Algorithm for a SAS Wide-Port RAID Controller

(75) Inventors: Gowrisankar RADHAKRISHNAN, Rochester, MN (US); Harun SAGLIK, Rochester, MN (US)

Correspondence Address: OPPEDAHL & OLSON LLP, P.O. BOX 4850, FRISCO, CO, 80443-4850, US

(73) Assignee: ADAPTEC, INC., Milpitas, CA (US)

(21) Appl. No.: 11/163,348

(22) Filed: Oct. 15, 2005

Related U.S. Application Data
(63) Continuation of application No. PCT/IB05/53220, filed on Sep. 30, 2005.
(60) Provisional application No. 60/595,681, filed on Jul. 27, 2005.

(51) Int. Cl. G06F 13/28; G06F 7/00

(52) U.S. Cl. 711/158; 707/102

(57) ABSTRACT

In an operation sequence queue, a single headpointer is used with two tailpointers to identify operations to be passed to SAS engines in a wide-port environment. The order of execution of commands is preserved despite being performed in an SAS wide-port RAID controller having multiple SAS engines.

### CROSS-REFERENCE TO RELATED APPLICATIONS

This application is a continuation of international application number PCT/IB2005/053220, filed Sep. 30, 2005, designating the United States, which application is incorporated herein by reference for all purposes. International application number PCT/IB2005/053220 claims priority from U.S. application No. 60/595,681, filed Jul. 27, 2005, which application is incorporated herein by reference for all purposes.

### BACKGROUND

The invention relates generally to storage systems using direct access storage devices, relates more particularly to storage systems using SAS (serial attached SCSI) wide-port interfaces, and relates most particularly to the difficult problem of working out how to keep all of the paths within the SAS wide-port interface busy as much of the time as possible, while avoiding adding unneeded complexity to storage adapter firmware and permitting load allocation among SAS engines.

FIG. 10 shows an exemplary modern-day storage system including a host 100, a storage adapter 101, and storage devices 102. The host 100 and storage adapter 101 are communicatively coupled by a suitable communications link 104 such as a SAS link. Historically the storage devices 102 could be any of a range of DASD (direct access storage devices) and historically the storage adapter 101 and the storage devices 102 could be linked by any of a range of DASD communications links. The storage devices might historically have been SCSI or SATA disk drives, and the link might historically have been a SCSI or SATA link.

In more recent times, makers of storage systems and components of storage systems have developed SAS (serial attached SCSI) where SCSI means “small computer system interface”. SAS links permit data transfers of very high bandwidth as compared with older SCSI links. SAS links permit addressing of more devices as compared with older SCSI links. SAS cabling is narrower and thus does not interfere with circulation of cooling air as much as older SCSI cabling. The SAS arrangement of FIG. 10 shows an SAS link 104 connecting to an SAS expander 105, which connects to individual SAS devices 102.

SAS offers the designer an opportunity to set up “narrow” SAS ports and “wide” SAS ports. A wide SAS port can contain “wide” SAS links, while a narrow SAS port cannot contain a wide SAS link. A wide SAS link is able to contain more than one physical link. In a storage system, each physical link is driven by an “SAS engine.” From the point of view of maximizing the performance of the storage system, it is desirable to keep all of the physical links within the wide SAS port busy as much of the time as possible—or stated differently, it is desirable not to hold back unnecessarily any traffic from the wide port. From the point of view of the system designer this goal reduces to the goal of trying to keep each of several SAS engines busy as much of the time as possible.

For many users of storage systems, it is important to achieve high performance as well as high reliability, and to this end many storage systems use RAID (redundant array of inexpensive disks). With RAID it is possible to reduce greatly the risk of loss of data even in the event of loss of one disk drive, and depending on the level of RAID employed it can even be possible to minimize the loss of data in the event of loss of two disk drives. RAID striping can also improve the performance of the storage system as compared with a system that does not use striping.

While RAID offers these and other benefits, RAID imposes burdens on the designer of the part of the system that interfaces with the storage devices (e.g. disks). There are many “write” transactions that involve writing to two or more drives at a time, and there may well be “read” transactions interleaved with the “write” transactions. Each “write” transaction may be composed of a number of smaller operations, and there are many situations where the operations need to be executed in strict sequence.

With some DASD link types that predate SAS, the order of execution of operations is automatically (that is, necessarily) preserved and nothing about the link presents any risk of operations being executed out of order. With SAS, however, there can be several SAS engines communicating with any of a (possibly) large number of SAS devices, and the unwary designer could end up with a situation where the system design would permit operations (perhaps passed to distinct SAS engines) to get executed out of order. Such out-of-order execution would inexorably lead to corruption of stored data and a system that permitted such out-of-order execution would be wholly unacceptable to any actual user.

FIG. 9 shows an exemplary ASIC 202 which might be used to keep track of SAS operations. Microprocessor 303, running firmware 304, inserts operations into OSQ 305. Logic 306 extracts operations from OSQ 305 and passes them to an SAS engine 308. The SAS engine 308, via SAS interface 302, executes the operations upon the SAS drives 102 (FIG. 10).

Today, maintaining and guaranteeing the order of execution of commands to SAS Devices is implemented using an OSQ (operation sequence queue) with a single headpointer and tailpointer. This may be analogized with a FIFO (first-in first-out) stack. Each new entry is added to the stack at the “head” and the headpointer is “bumped” or moved to show that the new entry is at the headpointer. Each entry that is deleted from the stack is deleted at the “tail” and the tailpointer is bumped to show that the entry that used to be second from the tail is now at the tail. In a RAID system there will be RAID firmware which has the task of making RAID happen (receiving data that is to be written, calculating parity or redundancy values, breaking up the to-be-stored information into the stripe or stripes to which it is to be stored, and issuing commands or operations to make the storage happen. The RAID firmware likewise has the task of rebuilding a drive in the event of drive failure, drawing upon redundant information in the other drives of the system, and in doing so it again issues operations to make the rebuilding happen. (It will be appreciated that while this discussion often uses the term “drive”, the benefits of the invention offer themselves for systems composed of any of a variety of types of storage devices.) It is thus the firmware that issues commands or operations, and that inserts them into the OSQ, generally at the “head” end. Each time firmware inserts another operation into the OSQ it bumps the headpointer accordingly.

It is important that the firmware be able to know where the tailpointer is as well. The OSQ is typically treated as a wraparound memory (e.g. a ring or loop) so that the head “chases the tail.” In an OSQ with space for 256 entries (which is typical) then firmware will know that the OSQ is full (and thus will know not to store any new entries) by noticing that the headpointer has reached the tailpointer. (Hopefully in a well dimensioned system the OSQ will rarely or never always get full, and there will always be at least a few unused entries between the headpointer and the tailpointer.) In FIG. 9 can be seen a microprocessor 303 executing firmware 304, and from time to time it takes action with respect to OSQ 305. In most cases the action which the firmware 304 takes with respect to OSQ 305 is in the nature of inserting one or more operations into the OSQ, and bumping the headpointer accordingly.

In a typical system there is logic (306 in FIG. 9) or firmware that has the task of “dequeuing” operations. By dequeuing is meant that an operation is removed from the OSQ and is dispatched to be executed at a storage device. Each time an operation is removed from the queue, the tailpointer is bumped accordingly.

The headpointer is incremented by hardware after a new command is added to the “Operation Sequence Queue” (OSQ), whereas the tailpointer is incremented after the command is transmitted for the current OSQ entry.

This prior-art approach employing a single headpointer and a single tailpointer serves the desired purposes discussed above in the special case of a system having a single SAS engine. Part of why this prior-art approach does not come to ruin is that because there is only a single engine, operations cannot get out of order. Also in the case where there is only a single engine there is only one pipeline to keep full, or to put it differently, the question of keeping each of several pipelines busy all the time does not even arise.

But when the system designer departs from a single-engine system and chooses to use an SAS wide-port design, the use of a single headpointer and single tailpointer turns out to be far from ideal. With a single headpointer and single tailpointer, commands are executed in a single-threaded fashion (rather than multi-threaded) and this leads to poor performance—some of the pipelines in the wide port will go idle while another pipeline in the wide port is busy.

Faced with the problem of trying to get close to the maximum potential bandwidth out of the wide port (that is, to minimize how often any one or more of the pipelines is idle or less than fully used), system designers have tried two approaches.

A first approach for keeping multiple SAS engines busy. A first approach is to have as many dedicated OSQs as there are SAS engines. Each OSQ would contain operations to be performed by its respective SAS engine, and in this way each SAS engine could be kept busy, thereby maximizing the benefit derived from the fact of the SAS port being “wide”. In this first approach, each OSQ array would then employ the above mentioned single head/tail pointer implementation.

One drawback to this approach, however, is that this approach dramatically reduces and limits the number of operations that can be outstanding at any given time for each SAS engine. For example, a 256-entry OSQ serving four engines will need to be split into four OSQs with 64 entries each.

A second drawback to this approach is that depending on the workload, it might be desired to be able sometimes to queue more than (say) 64 commands to a particular SAS engine, yet it would not be possible to do so, as the rest of the OSQ space is dedicated to various other SAS engines.

A second approach for keeping multiple SAS engines busy. The other known approach is to have a single headpointer and multiple tailpointers, with a respective tailpointer dedicated to each engine. With this approach, logic 306 (FIG. 9) selects one of the tailpointers, and works its way through the queue looking for an entry that is valid for the SAS engine associated with that tailpointer, and if one is found, then the operation is dispatched to that SAS engine. Logic 306 then repeats the process with each of the other (e.g. the other three) tailpointers, in each case trying to find an operation that can be dispatched to the respective SAS engine. This approach has the advantage that it is unlikely to “starve” any one of the SAS engines of work, and thus is unlikely to waste bandwidth due to nonuse.

A chief drawback to this approach is that it creates added burden and complication whenever firmware decides to manipulate the queue. Stated differently, the interface between the OSQ and the RAID firmware would need to be much more complicated than it would normally need to be, to be able to cope with more than one (e.g. four) tailpointers.

There is thus a great need for an approach which would preserve order of execution of operations, and which would minimize loss of bandwidth on an SAS wide port, all without adding to the complexity of the pre-existing interface with RAID firmware. It would be desirable as well if the approach could be simple and readily accomplished in hardware logic. It would be desirable if the approach, in addition to satisfying these demands, could also perform “lookaheads” to work on entries, maximizing the number of operations per engine.

### SUMMARY OF THE INVENTION

In an operation sequence queue, a single headpointer is used with two tailpointers to identify operations to be passed to SAS engines in a wide-port environment. The order of execution of commands is preserved despite being performed in an SAS wide-port RAID controller having multiple SAS engines.

### DESCRIPTION OF THE DRAWING

The invention will be described with respect to a drawing in several figures.

FIGS. 1, 4, 5, 6 and 8 show an operation sequence queue (OSQ);

FIGS. 2, 3 and 7 show a buffer relating to SAS engines;

FIG. 9 shows in functional block diagram form an ASIC (application-specific integrated circuit) relating to the invention;

FIG. 10 shows a typical storage system of a type which can make use of the invention; and

FIG. 11 shows in functional block diagram form an interface card.

### DETAILED DESCRIPTION

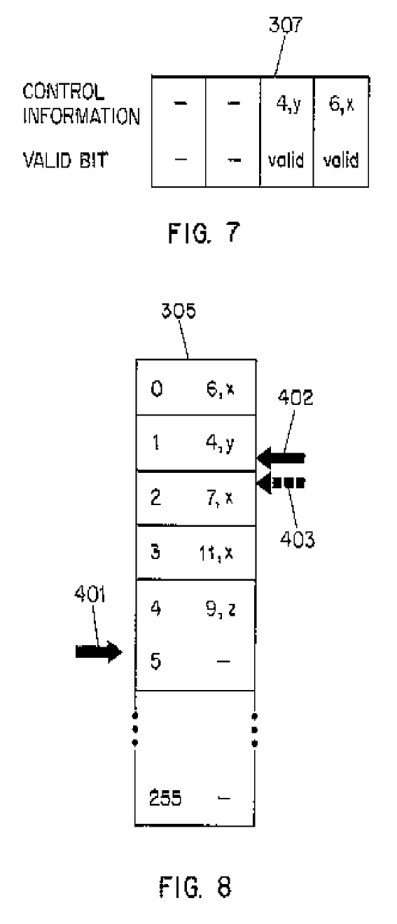

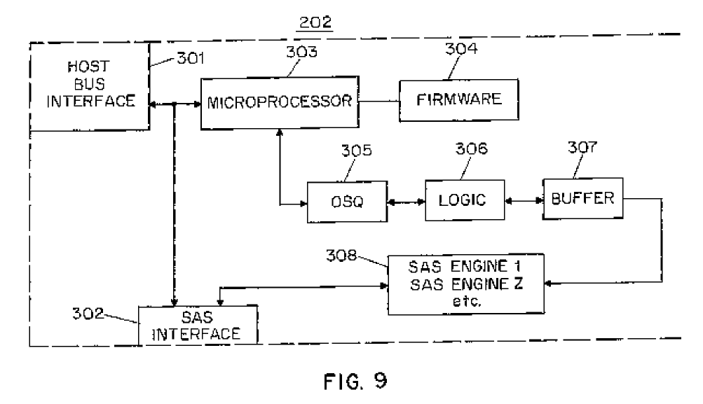

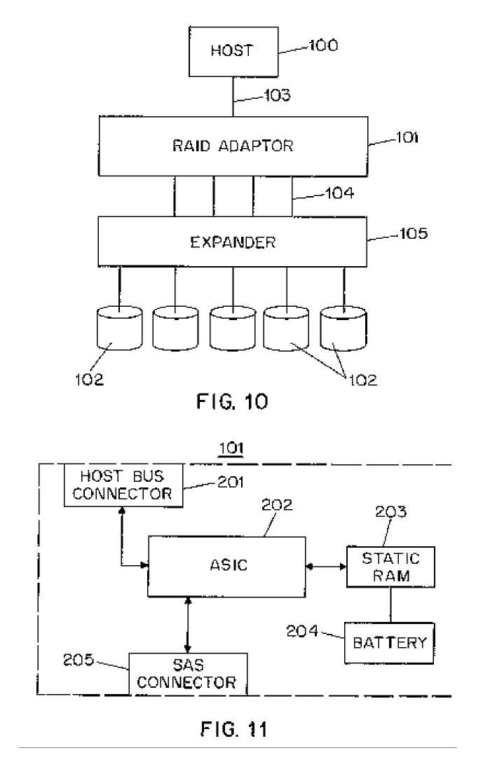

Turning first to FIG. 11, what is shown is an interface card, such as a RAID adapter card 101, which can benefit from the teachings of the invention. The card 101 has a host bus connector 201 for connection to a host (e.g. 100 in FIG. 10). The card 101 has an SAS connector 205 for connection (for example) to an SAS expander 105 (FIG. 10). It has an ASIC 202, detailed for example in FIG. 9. The ASIC 202 connects with a static RAM 203 which in an exemplary embodiment is nonvolatile RAM due to battery backup 204 which may be a lithium battery.

Returning to FIG. 10, it will be appreciated that the RAID adapter 110 in FIG. 10 can be the adapter 101 detailed in FIG. 11.

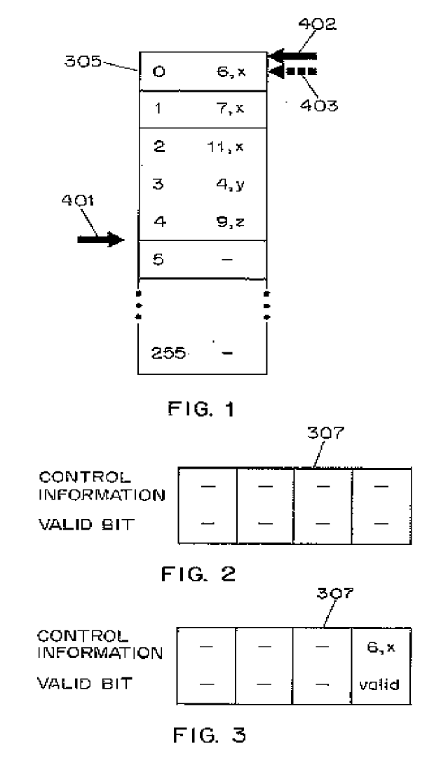

The invention provides a new queuing service algorithm called the Ripple Queuing Service that guarantees command sequencing and that simultaneously services multiple SAS engines. It will be seen that this new algorithm reduces the hardware complexity and gives good performance in multi-engine designs, as compared with other past approaches. In its essence, the Ripple Queuing Service addresses the starving of engines by looking ahead and finding a valid entry on the queue to execute in parallel on different engines. It adapts a single headpointer (401 in FIG. 1) and two tail pointers (402, 403 in FIG. 1), only one of which is visible to Firmware (304 in FIG. 9). The headpointer is incremented to indicate a new entry on the queue 305. The first tailpointer_0 is incremented once an entry is dequeued and the second tailpointer_1 which is not visible to Firmware, looks ahead to find a valid entry to be executed on a different engine. This new approach eases the burden on Firmware tremendously and provides a very simple interface to work with.

Let us assume we have a list of entries queued in the OSQ 305 that is 256 entries in size as depicted in FIG. 1. The headpointer 401 is incremented several times to accommodate new entries. FIG. 1 shows arbitrarily selected entries 6,x, 7,x, 11,x, 4,y, and 9,z for purposes of illustration. The headpointer 401 is pointing at the entry 9.z which is understood to have been the entry that was most recently added to the OSQ 305 by firmware 304. The tailpointers 402, 403 in FIG. 1 are pointing at entry 6,x which is understood to be the oldest entry (that was added to the OSQ 305 by the firmware the longest time ago) that has not yet been removed from the queue for execution by an engine. In this example, at the point in time shown by FIG. 1, there are five operations waiting to be performed, and because the OSQ has room for 256 entries, this means that at this time there are 251 spare or unused storage locations.

How FIG. 1 would have been handled using the first of the above-mentioned prior-art approaches. Of course what is desired to happen is that sooner or later each of the entries in the OSQ 305 of FIG. 1 will be dispatched to an engine for execution. Using the FIFO approach mentioned above, the logic (306 in FIG. 9) would simply pick off the entries one by one, starting at the tailpointer 402 and bumping the tailpointer 402 down (toward the headpointer 401) each time. With that FIFO approach, however, if there is more than one engine, only one of the engines will receive tasks to perform and the other engines will be “starved” of work. This will waste bandwidth in the wide port that might otherwise have been put to use. Again with the FIFO approach it is simply not permissible to hand out tasks one by one to the various engines, because there is the danger that operations which were meant to be in a particular sequence might get executed out of sequence.

How FIG. 1 would have been handled using the second of the above-mentioned prior-art approaches. With the second of the prior-art approaches, there would be as many tailpointers in FIG. 1 as there are SAS engines. Each tailpointer would be used to sweep through the list of entries, looking for operations that might be performed by a particular engine without risking getting things out of sequence. Firmware, however, would have no choice but to be designed to pay attention to each and every tailpointer, since at any given instant any one of the tailpointers might be the “last” one, namely the one that sets a limit to how many times the headpointer can be “bumped” to permit adding another entry in the queue. There are many other aspects of firmware design which would necessarily get more complex if such multiple queues were employed.

The discussion now turns briefly away from prior-art approaches and returns to the invention.

Given the particular entries that were arbitrarily chosen for FIG. 1, it may be seen that the first 3 entries (6,x, 7,x, 11,x) are destined to SAS device X, whereas the fourth entry (4,y) is destined to SAS device Y, and the last entry (9,z) is destined to SAS device Z. It is important to understand that it would be a mistake to dispatch the first three entries to three different SAS engines, because then there is the danger that the engines would execute the operations out of the intended sequence. Saying this in a different way, at the time that the first entry (6,x) is in the hands of a particular SAS engine (308 in FIG. 9), it is crucially important not to send the second or third entries to any SAS engine other than the one that has the first entry (6,x).

How FIG. 1 would have been handled using the first of the above-mentioned prior-art approaches. Returning briefly to a discussion of prior-art approaches, under the first of the prior-art approaches, there would be as many queues as there are SAS engines. Every entry will get put into a queue for a particular SAS engine, only after some provision has been made to ensure that nothing could previously have been queued to some other SAS engine has an “order” relationship with the entry presently being queued. Stated differently, for a group of operations that all need to have their order preserved, they will all be queued to a particular one of the SAS engines. As mentioned earlier, this limits flexibility that might otherwise have been available to allocate tasks in real time across the various SAS engines. And as mentioned earlier, this puts an upper bound (and a small upper bound) on the number of tasks that can be queued up for any particular SAS engine.

Returning now to the invention, the inventive approach using two tailpointers will be described in considerable detail.

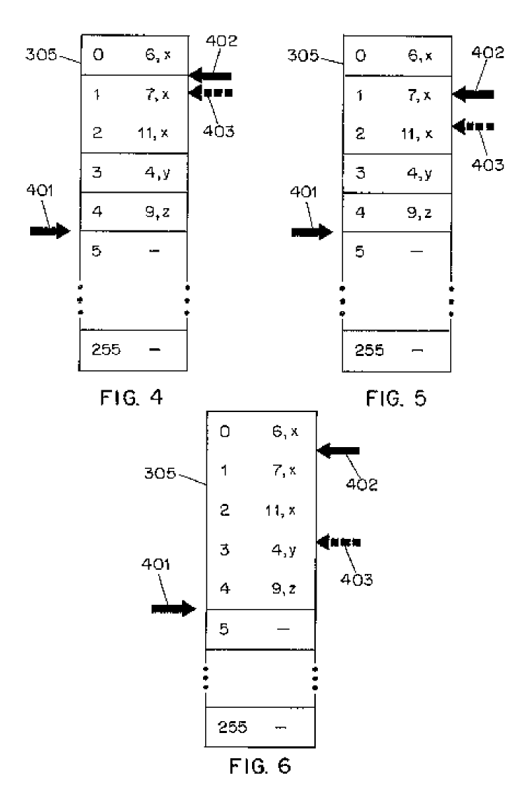

FIG. 9 shows a buffer 307. Logic 306 according to the invention extracts entries from the OSQ 305 one by one, and inserts them into the buffer 307. The buffer 307 is shown in more detail in FIG. 2. In this embodiment the buffer 307 may have four 64-bit spaces, each able to contains an SAS address and a pointer to a task, and a validity bit associated with the operation. The buffer 307 allows distributing active paths to the various SAS engines, and makes it easy to monitor, for each SAS engine, the currently active path for that engine. The valid bit is set whenever a path is dequeued from the queue 305 for future comparison and the valid bit is cleared once the operation is finished (that is, once the SAS engine has done what it was asked to do).

Returning to FIG. 1, assume that the queuing process has just begun, namely that logic 306 has just started its activity. This means that none of the SAS engines 308 (FIG. 9) is active and thus that the buffer 307 (FIG. 9) is empty. Logic 306 looks to see where the tailpointer 402 (FIG. 1) is pointing, namely at the first entry (6,x). After obtaining the SAS address for the first entry, the logic 306 concludes that the entry belongs to SAS device X. It is important to find out whether any of the SAS engines 308 is presently carrying out any operation with respect to SAS device X, and the answer to this question may be found in buffer 307 as shown in FIG. 2. Logic 306 compares X with all the addresses in the remaining 3 buffer spaces in buffer 307, to see whether any SAS engine happens to be carrying out any operation on device X. If the comparison comes up empty (that is, that no SAS engine is presently doing such a thing) then logic 306 asserts the valid bit in buffer 307 with respect to entry (6,x). In this particular case, logic 306 concludes that none of the 64-bit addresses matches with the first entry engine address (6,x), and so the entry is placed into the buffer 307 as depicted in FIG. 3. Logic 306 then and increments (or “bumps”) both tailpointer_0 402 and tailpointer_1 403 as depicted in FIG. 4.

Returning to FIG. 3, the fact that the (6,x) entry is in the buffer 307, and that the “valid” bit is set, means that the SAS engine 308 corresponding to that portion of the buffer 307 will set to work executing the operation. Eventually the SAS engine 308 will complete its work and the buffer 307 will be updated to reflect that the task has been completed.

Returning to FIG. 4, the tailpointer 402 now points to task (7,x) where previously (in FIG. 1) it pointed to task (6,x). This is indicative of the fact that task (6,x) has been given to an SAS engine for execution, and that the (7,x) task is now the oldest one that has not yet been given to an SAS engine for execution.

Logic 306 next obtains the engine address of the second entry (entry 7,x) i.e. path number 7, and it concludes that this entry, too, belongs to SAS device X. At this point in time, if logic 306 were to dequeue this entry (that is, if logic 306 were to extract the entry from the OSQ 305 and insert it as a valid task into buffer 307) the result would be a failure to guarantee the sequenced order of operation, namely that the (6,x) task is supposed to be executed prior to the (7,x) task. This means that logic 306, in keeping with the invention, will not extract the (7,x) task from the OSQ 305 and will not place it into the buffer. Rather, the Ripple Queuing Service increments only the tailpointer_1 as seen in FIG. 5. The outcome is that the tailpointer 1 403 now no longer points to task (7,x) but instead it now points to task (11,x).

Now, the engine address of the entry that the tailpointer_1 is pointing to i.e. path number 11 (task 11,x) is obtained by logic 306 and overwritten on buffer space 307 as a candidate task that may or may not be given to an SAS engine for execution. Logic 306 then carefully inspects the buffer 307 to see whether any SAS engine is presently carrying out any task with respect to address X. There are two possible outcomes.

Outcome number 1. Assuming that the condition of the buffer 307 continues to be in the state shown in FIG. 3, once again logic 306 realizes that the engine address (the X of 11,x) of this entry is same as X which is already valid in the (6,x) task in FIG. 3. Here, again, if the (11,x) task were given to an SAS engine there is the danger that the correct order of operation would not be preserved. Thus the entry (11,x) is not validated in the buffer 307.

Outcome number 2. The other possibility could be that when logic 306 checks for the validity of this third entry (that is, checks to see whether buffer 307 shows any SAS engine to be carrying out some operation on the address X), logic 306 may find that the valid bit for the first entry (6,x) is no longer valid (is deasserted). This would mean that the SAS engine that had been working on the (6,x) task had finished its work and had cleared the “valid” bit in the buffer 307. In that case the logic 306 would move the tailpointer 403 back to the same place as the tailpointer 402 so as to start all over again with looking for the oldest operation not yet executed. But that is not what happens in the present example.

In the present example, we assume that the valid bit in the buffer 307 for the first entry (6,x) is still valid. Stated differently, this means that the SAS engine that is working on the task (6,x) is not yet done performing the task. In this case, logic 306 we again increment the tailpointer_1 403 as seen in FIG. 6.

It will be appreciated that at this point, three of the four SAS engines is idle and has been idle since the queuing began. Only one SAS engine, the one that is working on the (6,x) task, is doing anything. Most of the bandwidth of the wide port (carrying SAS wide link 104 in FIG. 10) is being wasted. Fortunately this unhappy state of affairs will not persist, as will now be seen.

Now, the engine address of the entry that the tailpointer_1 is pointing to i.e. path number 4 (operation 4,y) is obtained by logic 306 and is and overwritten on buffer space 307 as a candidate task that might be given to an SAS engine. This time when logic 306 does the comparison of buffer space 307 with all the other addresses we see that it is exclusive. Stated differently, the SAS address Y does not appear anywhere else in the buffer 307 (the only other address in the buffer 307 is the x of operation (6,x) as shown in FIG. 3). In other words, no other task is presently being handled by any of the SAS engines that presents a risk of getting out of sequence with the operation (4,y).

Therefore, logic 306 reflects this operation (4,y) as depicted in FIG. 7 and dequeues the entry from the OSQ 305.

It will be appreciated, however, that the removal of the entry (4,y) is not done by bumping the tailpointer 0 402 (as would be done in a simple FIFO approach) for the simple reason that the entry (4,y) is not the “last” or “oldest” entry.

In accordance with this embodiment of the invention, logic 306 proceeds as will now be described. The entry that has been moved to buffer 307 (namely the 4,y entry) is moved in the OSQ to a place that is after the recent valid entry i.e. 6,x. The logic 306 must then bring about a ripple-effect move for the remaining entries i.e. path numbers 7,x and 11,x. Logic 306 then increments tailpointer_0 and equates tailpointer_1 to tailpointer_0 which is seen in FIG. 8.

Now, the process of finding the next valid entry for a different SAS Device follows the above illustrated process.

Eventually, all of the buffer spaces in buffer 307 will get filled, which means that all of the SAS engines 308 will have work to do. At that point the wide link 104 of the wide port will get put fully to use and the maximum theoretical bandwidth will be obtained from the link.

It is instructive, the above discussion having taken place, to elaborate upon the interface between this queuing system (OSQ 305, logic 306, and buffer 307) and the firmware of microprocessor 303 and firmware 304.

In this embodiment, firmware 304 is given the flexibility to manipulate the queue (OSQ 305) to add or remove entries. Of course such manipulation cannot be permitted to take place at the same time that logic 306 is manipulating the OSQ 305. To manipulate the Queue (OSQ 305), firmware 304 sets a bit in a register in hardware, which halts logic 306. By “halting logic 306” is meant that the above process of finding the next valid entry in the queue (discussed in connection with FIGS. 1-8) is halted. Once the bit is set, firmware can read and write the OSQ and change the pointers as per firmware's requirement. After the manipulation by firmware is done, firmware clears this bit (which can be called a “freeze bit”) to allow logic 306 to continue to execute operations.

Problems Solved by the Invention

From the discussion above, it may be seen that the invention solves several problems.

Single-threading of operations in a SAS wide-port design resulting in poor performance. The simplest way in which a system designer might try to ensure the preservation of the correct order of execution of operations is, as mentioned above, to single-thread the operations. This does indeed preserve the order of operations, but loses any prospect of gaining the entire bandwidth which a wide port could offer, and in fact loses most of that bandwidth.

Limitation of number of operations for each SAS engine. Yet another way of preserving operation order, as mentioned above, might have been to set up a distinct OSQ for each SAS engine. This means, however, that each OSQ is perhaps one-fourth as big. That limits the number of operations that can be queued up for the engine corresponding to a queue.

Difficulty of manipulation and control of the “Operation Sequence Queue” by the Firmware. If multiple tailpointers are used (one for each of the SAS engines) then the firmware interface to the OSQ is much more complicated than usual.

In summary, “Ripple Queuing Service” (RQS) employs two different tail pointers that enables SAS wide ports to execute multiple commands simultaneously, while nonetheless maintaining the order of the commands. Also, the operation completion rate of the SAS RAID adapter is enhanced as compared with a single-threaded approach.

The approach according to the invention supports the dynamic swapping of entries. This feature allows the queue to execute valid entries (namely entries destined for different engines) in parallel. This idea promotes the execution of more operations in a single-queue design without having to wait for the current entry to finish its operations before dequeuing the next entry.

This invention allows providing firmware a dynamic yet simple interface to work with. The firmware will have access only to the headpointer and the first tailpointer along with a ‘freeze’ feature to manipulate the contents as deemed necessary. It will be appreciated that the firmware does not need to have any access to (or knowledge of) the second tailpointer 403.

It will be appreciated that when firmware clears the freeze bit, the logic 306 must reset the tail 1 403 to match the new tail 0 402. Stated differently, logic 306 cannot be permitted to rely upon anything about the tail 1 403 after a freeze has come and gone.

It will be appreciated that those skilled in the art will have no difficulty at all in devising myriad obvious improvements and variants of the embodiments disclosed here, all of which are intended to be embraced by the claims which follow.

What is claimed is:

1. A queuing method for use with operations to be performed upon storage devices, at least some of which operations need to be executed in a particular order, the operations to be performed by at least first and second engines upon the storage devices, the method comprising the steps of:
inserting into a queue a first entry indicative of a respective operation with respect to a first storage device;
thereafter, inserting into the queue a second entry indicative of a respective operation with respect to the first storage device;
thereafter, inserting into the queue a third entry indicative of a respective operation with respect to a second storage device that is not the same as the first storage device;
the first entry thereby defining an oldest entry among the first, second, and third entries, and the third entry defining a newest entry among the first, second, and third entries;
assigning the operation of the first entry to a first one of the engines for execution and removing the first entry from the queue;
before assigning the operation of the second entry to any of the engines for execution, assigning the operation of the third entry to a second one of the engines for execution, and removing the third entry from the queue;
only after the first one of the engines has completed execution of the operation of the first entry, assigning the operation of the second entry to one of the engines for execution, and removing the second entry from the queue;
whereby the operations of the first and second entries are performed in the same order as the entries were inserted into the queue; and
whereby the operations of the first and third entries are performed in parallel.

2. The method of claim 1 wherein the first and second ones of the engines are serial-attached small-computer-system-interface (SAS) engines, and wherein the storage devices are SAS drives, and wherein the steps of performing operations upon storage devices are performed via an SAS wide link over an SAS wide port.

3. A queuing method for use with operations to be performed upon storage devices, at least some of which operations need to be executed in a particular order, the operations to be performed by at least first and second engines upon the storage devices, the method comprising the steps of:
a. providing a queue containing entries in an order from oldest to newest, each entry indicative of a respective operation with respect to a particular one of the storage devices, the queue defining an oldest entry among the entries;
b. setting a pointer to point to the oldest entry in the queue;
c. if there is an engine that is not performing any operation upon any of the storage devices, inspecting the pointed-to entry see whether any of the engines is presently performing an operation upon the particular one of the storage devices of which the pointed-to entry is indicative;
d. in the event that none of the engines is presently performing an operation upon the particular one of the storage devices of which the pointed-to entry is indicative, causing one of the engines to commence performing the respective operation of the pointed-to entry upon the particular one of the storage devices of which the pointed-to entry is indicative and removing the pointed-to entry from the queue, and resetting the pointer to point to the oldest entry in the queue;
e. in the event that one of the engines is presently performing an operation upon the particular one of the storage devices of which the pointed-to entry is indicative, bumping the pointer to a next newest entry in the queue;
and repeating steps b, c, d and e so long as there are entries in the queue.

4. The method of claim 3 wherein the engines are serial-attached small-computer-system-interface (SAS) engines, and wherein the storage devices are SAS drives, and wherein the steps of performing operations upon storage devices are performed via an SAS wide link over an SAS wide port.

5. Apparatus for use with operations to be performed upon storage devices, at least some of which operations need to be executed in a particular order, the apparatus comprising:
at least first and second engines communicatively coupled with the storage devices;
a queue disposed to contain entries in an order from oldest to newest, each entry indicative of a respective operation with respect to a particular one of the storage devices, the queue defining an oldest entry among the entries;
a pointer settable to point to a particular one of the entries in the queue;
first means initially setting the pointer to point to the oldest entry in the queue;
second means responsive to a condition of an engine not performing any operation upon any of the storage devices for inspecting the pointed-to entry see whether any of the engines is presently performing an operation upon the particular one of the storage devices of which the pointed-to entry is indicative;
the second means responsive to a condition that none of the engines is presently performing an operation upon the particular one of the storage devices of which the pointed-to entry is indicative, for causing one of the engines to commence performing the respective operation of the pointed-to entry upon the particular one of the storage devices of which the pointed-to entry is indicative, for removing the pointed-to entry from the queue, and for resetting the pointer to point to the oldest entry in the queue;
the second means responsive to a condition that one of the engines is presently performing an operation upon the particular one of the storage devices of which the pointed-to entry is indicative, for bumping the pointer to a next newest entry in the queue.

6. The apparatus of claim 5 wherein the engines are serial-attached small-computer-system-interface (SAS) engines, and wherein the storage devices are SAS drives, and wherein the performing of operations upon storage devices is performed via an SAS wide link over an SAS wide port.

7. The apparatus of claim 5 further comprising a freeze bit, the first and second means halting when the freeze bit is set, the first and second means resuming operation when the freeze bit is cleared and responsive to a condition of the freeze bit being cleared for resetting the pointer to point to the oldest entry in the queue.

8. The apparatus of claim 6 wherein the number of SAS engines is four.
